(19) United States
(12) Patent Application Publication
(10) Pub. No.: US 2026/0260835 A1
(43) Pub. Date: Sep. 3, 2026

(54) ELECTRICAL PROTECTION SYSTEM FOR AIRCRAFT, WITH SUPERCONDUCTIVE FUSE CONNECTION

(71) Applicant: Airbus SAS, BLAGNAC (FR)

(72) Inventors: Edwin CALDERON MENDOZA, BLAGNAC (FR); Pedro BARUSCO, BLAGNAC (FR); Swapnil KHARCHE, BLAGNAC (FR); Camille CHAPER, BLAGNAC (FR); Ludovic YBANEZ, BLAGNAC (FR); Emelie NILSSON, BLAGNAC (FR); Jean-Francois ROUQUETTE, BLAGNAC (FR)

(21) Appl. No.: 19/550,484

(22) Filed: Feb. 26, 2026

(30) Foreign Application Priority Data
Feb. 28, 2025 (FR) FR2502031

(51) Int. Cl. H01H 85/041

(52) U.S. Cl. CPC H01H 85/041

(57) ABSTRACT

An electrical protection system for an electrical connection of an electrical circuit of an aircraft, for example an aircraft powered by hydrogen, comprising a fuse element made of a material which exhibits superconducting properties in a superconducting state, and non-superconducting properties in a normal state, the transition from the superconducting state to the normal state releasing transition energy, the protection system also comprising a device, called the safety device, designed to open the electrical connection when the fuse element changes from the superconducting state to the normal state.

### CROSS-REFERENCE TO RELATED APPLICATIONS

This application claims the benefit of French Patent Application No. FR2502031 filed on Feb. 28, 2025, the entire disclosure of which is incorporated herein by way of reference.

### FIELD OF THE INVENTION

The present invention relates to an electrical protection system for an electrical connection of an electrical circuit of an aircraft, particularly an aircraft powered by hydrogen.

### BACKGROUND OF THE INVENTION

In an effort to reduce the carbon impact caused by aviation, the Applicant has developed aircraft designs the motors of which are hydrogen-powered. To improve the competitiveness of this type of propulsion, the Applicant has developed specific equipment, in particular, a propulsion chain comprising a superconducting motor. Such a chain makes it possible to conduct currents having higher strengths, and it then proves necessary to reliably manage such high nominal operating currents, and fault currents that are even higher.

The aim of the invention is to improve the present situation.

### SUMMARY OF THE INVENTION

To this end, there is proposed an electrical protection system for an electrical connection of an electrical circuit of an aircraft, for example an aircraft powered by hydrogen and/or comprising a superconducting motor, comprising an element, called the fuse element, made of a material which exhibits superconducting properties in a first state, called the superconducting state, and non-superconducting properties in a second state, called the normal state, the transition from the superconducting state to the normal state releasing transition energy, the protection system also comprising a device, called the safety device, designed to open the electrical connection when the fuse element changes from the superconducting state to the normal state.

Thus, in the event of a short circuit in the electrical circuit, the current increases suddenly, triggers the transition from the superconducting state to the normal state of the fuse element, and the safety device opens the electrical connection, this effectively protecting the electrical circuit.

According to another aspect, the system comprises a heat exchanger thermally connected to the fuse element, designed so as to keep the fuse element in the superconducting state.

According to another aspect, the safety device is a means for absorbing the transition energy.

According to another aspect, the means for absorbing the transition energy comprises silica.

According to another aspect, the silica is designed to melt under the effect of the transition energy, then solidify by cooling.

According to another aspect, the means for absorbing the transition energy is in the form of a gel.

According to another aspect, the material of the fuse element is BSCCO and/or YBCO and/or MgB₂ and/or REBCO.

According to another aspect, the protection system comprises said electrical connection.

Another subject of the invention is an electrical circuit, for example a propulsion chain of an aircraft, the propulsion chain comprising a superconducting motor, the circuit comprising the protection system as described above.

Another subject of the invention is an aircraft comprising an electrical circuit as described above.

### BRIEF DESCRIPTION OF THE DRAWINGS

Further features, details and advantages will become apparent on reading the detailed description below, and on studying the attached drawings, in which:

FIG. 1 is a schematic view of a longitudinal section of an electrical protection system integrated into an electrical connection, according to the present invention, in a normal operating mode;

FIG. 2 is a detailed schematic view of the system of FIG. 1;

FIG. 3 illustrates the change over time of an electric current flowing through the electrical connection in the event of a short-circuit, according to successive phases A, B, C and D; and,

FIG. 4 is an aircraft include an electrical protection system according to one or more embodiment of the present invention.

### DETAILED DESCRIPTION OF THE PREFERRED EMBODIMENTS

The examples and the related conditions detailed here are mainly intended to help the reader understand the principles of the present invention and not to limit its scope to these specific examples and conditions. It will be understood that a person skilled in the art can conceive of various arrangements which, although not explicitly described or represented here, nevertheless embody the principles of the present invention and are included in its spirit and scope.

Furthermore, to facilitate understanding, the following description may describe relatively simplified implementations of the present invention. As a person skilled in the art will understand, other implementations of the present invention may be of greater complexity.

In some cases, examples of modifications of the present invention may also be presented. This is done simply to aid understanding, again rather than define the scope or establish the limits of the present invention. These modifications are not an exhaustive list, and a person skilled in the art may make other modifications while still remaining within the scope of the present invention.

Furthermore, all the statements below relating to the principles, aspects and implementations of the present invention, as well as the specific examples thereof, aim to encompass both the structural and functional equivalents thereof, whether they are currently known or developed in the future.

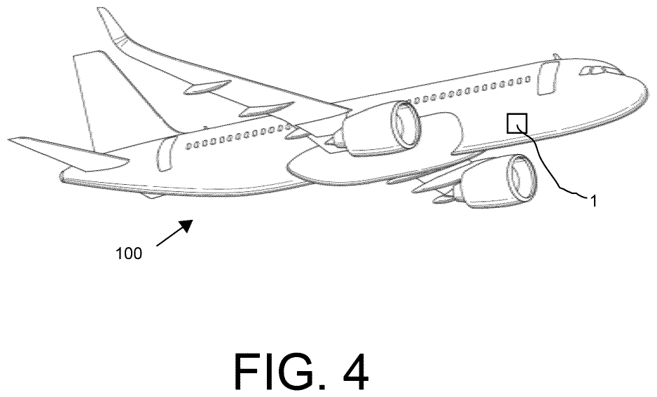

As can be seen from the figures, the subject of the invention is an electrical protection system 1 for an electrical connection 2. The electrical connection 2 forms part of an electrical circuit 3 of an aircraft 100 (see, FIG. 4), for example an aircraft powered by hydrogen. The electrical circuit 3 is, for example, a propulsion chain of the aircraft, comprising one or more superconducting devices, for example a superconducting motor.

In the figures, the connection 2 comprises a first cable, called the supply cable, referenced 4, a superconducting cable, referenced 5, and the protection system 1 disposed between the cables 4 and 5. The supply cable 4 is connected, directly or indirectly, to a fuel cell 6. The superconducting cable 5 is connected, directly or indirectly, to the propulsion unit 7.

As can be seen in the figures, the protection system 1 comprises a fuse element 10. In the embodiment illustrated, the fuse element 10 is in the form of a superconducting tape or link.

The fuse element 10 is made of a material which exhibits superconducting properties in a first state, called the superconducting state, and non-superconducting properties in a second state, called the normal state.

One of the known superconducting properties is that, in the superconducting state, the electrical resistance of the material is zero, whereas, in the normal state, the material has a non-zero electrical resistance.

The material is in the superconducting state when it is subjected to a temperature below a so-called critical temperature Tc and/or to a magnetic field called the critical magnetic field, corresponding to a critical electric current Ic.

Under the effect of a temperature greater than or equal to the critical temperature Tc and/or of an electric current greater than or equal to the critical current Ic, the material undergoes a transition from the superconducting state to the normal state which releases energy called transition energy. The transition energy may be released in the form of an electric arc. More precisely, during the transition from the superconducting state to the normal state, a quench occurs. The material begins to heat up then to melt. Lastly, when the molten material breaks, an electric arc is generated.

A superconducting material with a high critical temperature is preferably chosen.

The superconducting material is, for example, BSCCO (mixed oxide of bismuth, calcium, copper and strontium) and/or YBCO (mixed oxide of barium, copper and yttrium) and/or MgB₂ and/or ReBCO (mixed oxide of barium, copper and rare earth).

In the case of ReBCO, a tape of a few millimetres, for example between 1 mm and 10 mm, for example between 15 mm and 20 mm, for example between 10 mm and 15 mm in width, is chosen, for example. The length of the tape is a few centimetres, for example between 2 cm and 5 cm. The thickness is, for example, 100 nm. The critical current at a critical temperature Tc of 77 K is, for example, between 800 A and 1500 A, for example between 1000 A and 1200 A.

As can be seen from the figures, the protection system 1 also comprises a safety device 11 for interrupting the electrical connection 2 during the transition from the superconducting state to the normal state of the fuse element 10.

The safety device 11 is, for example, a means for absorbing the transition energy. During the transition from the superconducting state to the normal state, the energy, including in the form of a plasma electric arc, is absorbed by the safety device 11.

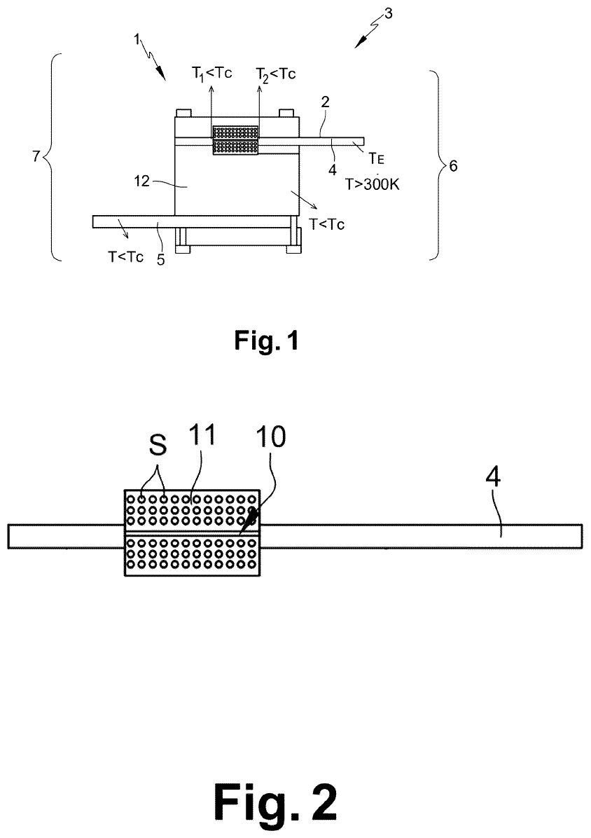

According to one variant, the means for absorbing the transition energy comprises a material with a high thermal capacity, such as silica, which is in the form of grains (denoted S in FIG. 2) in the normal operating configuration of the electrical connection 2. Under the effect of the transition energy, the silica grains melt, then solidify by cooling. The energy absorption makes it possible to cool the plasma arc, then extinguish it, and also guarantees its confinement without any leakage.

Alternatively or in addition, the means for absorbing the transition energy is in the form of a gel.

Advantageously, a box 12 contains the fuse element 10 and the safety device 11. In the box 12, the superconducting link connects the supply cable 4 to the superconducting cable 5. The heat exchanger 13 electrically connects a part (left in FIG. 1) of the fuse 10 to the superconducting cable 5.

As can be seen in the figures, the protection system 1 comprises a heat exchanger 13. The heat exchanger 13 is thermally connected to the box 12, to a portion of the supply cable 4 and/or a portion of the superconducting cable 5.

In the figures, the exchanger 13 is fixed to, preferably in contact with, the box 12. Preferably, the box 12 is made of a material having a very high thermal conductivity, this ensuring good thermal transfer between the heat exchanger 13 and the fuse element 10. It is, for example, a non-metal material which exhibits a reasonably low degassing rate in a vacuum environment and is thermally conductive and electrically insulating, like a ceramic, such as aluminium oxide.

In the figures, the heat exchanger 13 is fixed to, preferably in contact with, a portion of the supply cable 4.

In the figures, the heat exchanger 13 is fixed to, preferably in contact with, a portion of the superconducting cable 5.

The heat exchanger 13 ensures that the superconducting cable 5 and the fuse element 10 are kept at cryogenic temperature. Cryogenic temperature is understood to mean a temperature below the critical temperature of the cable 5 and of the fuse element 10. If the cable 5 and the fuse do not have the same critical temperature, the protection system 1 is designed so as to keep the temperature below the lowest of the two critical temperatures. The heat exchanger 13 is also designed to keep the superconducting link of the fuse element 10 at the cryogenic temperature between its two ends, preferably with a gradient of the temperature in the superconducting link (between the temperatures denoted T1 and T2 in FIG. 1) between 2 K and 5 K. The end 4^{E} of the cable 4 towards the fuel cell 6 is at ambient temperature, for example 300 K.

It is noted that the protection system 1 also comprises an electrically insulating and thermally conductive insulator, for example made of ceramic, in order to insulate the input and the output of the fuse element 10. The insulator also makes it possible to optimize the thermal transfers between the fuse element 10 and the heat exchanger 13.

The operation of the protection system 1, which can already be seen from the description above, will now be described.

In normal operating mode, in the electrical connection 2, a supply current (Ia) flows from the fuel cell 6 through the supply cable 4, through the superconducting link of the protection system 1, then through the superconducting cable 5 to the propulsion unit 7.

In the event of a short circuit, schematically, during a phase A, the electric current becomes greater than the critical current of the superconducting link 10, this breaking the superconducting link, the material passing from the superconducting state to the normal state. During a phase B, the transition from the superconducting state to the normal state generates the transition energy, in particular in the form of an electric arc, the amplitude of which depends on the power of the plasma arc and on the inductive energy stored in the electrical circuit. During a phase C, during which the temperature is, for example, of the order of 20,000 K, the silica grains melt, this allowing the released heat to be absorbed. The plasma arc is cooled then extinguished. During a phase D, the silica solidifies, this completely blocking the electric current. The electrical connection 2 is open and guarantees electrical isolation.

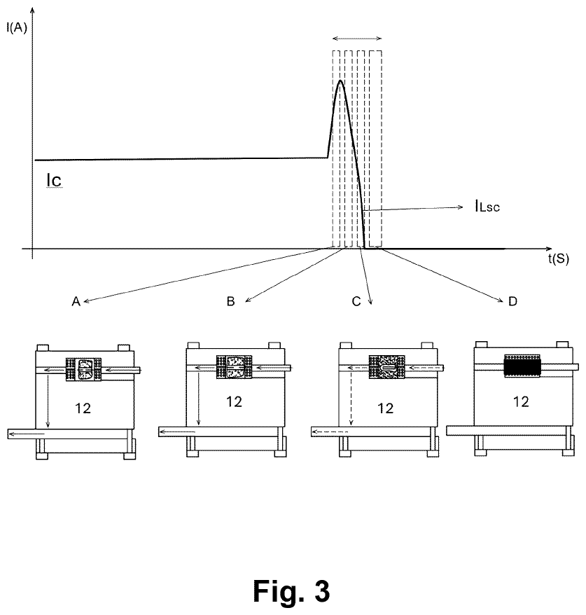

As illustrated in the figure, during the short circuit, the current increases rapidly, then decreases between phase A and phase D. The transition of the superconductor (quench) has a current-limiting effect. As the resistance increases during the transition, the current decreases. This is referred to as limited short-circuit current (of current denoted ILsc for “limited short-circuit”). At the end of phase D, the electric current is zero. The duration between phases A and D, represented by a double-headed arrow in FIG. 3, is a few milliseconds.

As already explained, the superconducting link guarantees a rapid transition between the superconducting state and the normal state when a short circuit occurs. During the transition, the superconducting link heats up and melts, possibly while generating a plasma electric arc. Because of the high current density flowing through the electrical connection 2, the energy for breaking the superconducting link is low, this ensuring that the protection system 1 reacts quickly in the event of a short circuit. In other words, the device 1 has little inertia, this making the protection system 1 very efficient.

Moreover, the material, in the normal state, has a slow electric current propagation speed, due to the non-zero electric resistance, this guaranteeing that the fault remains local and does not propagate.

Owing to the protection system 1, it is possible to open the electrical connection in less than 10 ms, while extinguishing the possible electric arc at the same time.

As can already be seen from the description above, the present invention has the following advantages:
rapid response,
electrical isolation,
very low energy losses in the normal operating state, at high currents,
very low thermal losses in thermal distribution and conduction at cryogenic temperature owing to the integration of the heat exchanger which ensures active cooling,
bidirectional operation,
confinement of the plasma arc in the box of the fuse element, without leakage; capacity to effectively absorb the plasma arc (produced in particular on highly inductive lines) when the superconducting link is opened. It is noted that the use of silica is very useful in the event of short circuits on highly inductive lines which may produce a higher-energy arc plasma when the superconducting connection is opened because silica allows better and homogeneous thermal termination, and,
compactness and low weight due to the integration of the heat exchanger and of the supply cable which are used as mechanical and electrical interfaces.

Modifications and improvements to the implementations described above of the present invention may occur to a person skilled in the art.

The above description is illustrative by means of examples rather than limiting. The scope of the present invention is therefore limited solely by the scope of the claims below.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claims is:

1. An electrical protection system for an electrical connection of an electrical circuit of an aircraft, the electrical protection system comprising:
a fuse element made of a material exhibiting superconducting properties in a first state, called a superconducting state, and non-superconducting properties in a second state, called a normal state, such that a transition from the superconducting state to the normal state releases a transition energy; and,
a safety device configured to open the electrical connection when the fuse element changes from the superconducting state to the normal state.

2. The protection system according to claim 1, further comprising:
a heat exchanger thermally connected to the fuse element and configured to keep the fuse element in the superconducting state.

3. The protection system according to claim 1, wherein the safety device is a means for absorbing the transition energy.

4. The protection system according to claim 3, wherein the means for absorbing the transition energy comprises silica.

5. The protection system according to claim 4, wherein the silica is configured to melt from the transition energy and solidify by cooling.

6. The protection system according to claim 3, wherein the means for absorbing the transition energy comprises a gel.

7. The protection system according to claim 1, wherein the material of the fuse element comprises BSCCO, or YBCO, or MgB₂, or ReBCO, or combinations thereof.

8. The protection system according to claim 1, further comprising:
the electrical connection.

9. An electrical circuit comprising:
a superconducting motor; and,
the protection system according to claim 8.

10. An aircraft comprising:
the electrical circuit according to claim 9.
